(19) United States
(12) Patent Application Publication
(10) Pub. No.: US 2024/0010054 A1
(43) Pub. Date: Jan. 11, 2024

(54) Glass Windows With Matched Edges and Joined Edges

(71) Applicant: Apple Inc., Cupertino, CA (US)

(72) Inventors: David E. Kingman, San Francisco, CA (US); Albert J. Golko, Saratoga, CA (US); Peter F Masschelein, Campbell, CA (US)

(21) Appl. No.: 18/471,164

(22) Filed: Sep. 20, 2023

Related U.S. Application Data
(63) Continuation of application No. PCT/US2022/023436, filed on Apr. 5, 2022.
(60) Provisional application No. 63/172,251, filed on Apr. 8, 2021.

(51) Int. Cl. B60J 1/00; B32B 17/10

(52) U.S. Cl. CPC B60J 1/008; B60J 1/001; B32B 17/10045; B32B 17/10495; B32B 17/1055; B32B 17/10541; G02B 6/0095

(57) ABSTRACT

A system may have windows. Each window may have inner and outer glass layers laminated together with polymer. Optical component layers may be incorporated into the polymer or the polymer may be free of embedded components. To avoid mismatch between adjacent window edges in systems with multiple adjacent windows, adjacent windows may be formed from shared-cut-edge-matched window panel sections that are cut from a common window panel. Windows may be formed from a single portion of laminated glass or may be formed by joining multiple smaller pieces of laminated glass together along a seam.

This application is a continuation of international patent application No. PCT/US2022/023436, filed Apr. 5, 2022, which claims priority to U.S. provisional patent application No. 63/172,251, filed Apr. 8, 2021, which are hereby incorporated by reference herein in their entireties.

### FIELD

This relates generally to structures that pass light, and, more particularly, to windows.

### BACKGROUND

Windows are used in buildings and vehicles. Windows may be formed from glass or other transparent material.

### SUMMARY

A system such as a building or vehicle may have windows. Windows may be formed by laminating together glass layers with polymer. If desired, a light guide that distributes illumination across a window and/or other optical component layers may be embedded within the polymer.

The windows may include windows that are mounted adjacent to each other in a support structure such as a vehicle body. To avoid mismatch between adjacent window edges in systems with multiple adjacent windows, adjacent windows may be formed from shared-cut-edge-matched window panel sections. These window panel sections may be separated along a cut line from a common window panel. When mounted adjacent to each other in a system, the shared-cut edges of the opposing sections may face each other and be aligned with each other.

The system may also include windows that are formed by joining multiple pieces of laminated glass together. For example, first and second laminated glass portions may be joined along a half-lap joint or other seam.

### BRIEF DESCRIPTION OF THE DRAWINGS

FIG. 1 is a diagram of an illustrative system with windows in accordance with an embodiment.

FIG. 2 is a cross-sectional side view of an illustrative window in accordance with an embodiment.

FIG. 3 is a view of an illustrative window in accordance with an embodiment.

FIGS. 4 and 5 are cross-sectional side views of the illustrative window of FIG. 3 in accordance with embodiments.

FIG. 6 is a perspective view of an illustrative window with a developable surface in accordance with an embodiment.

FIGS. 7 and 8 are cross-sectional side views of the illustrative window of FIG. 6 in accordance with embodiments.

FIG. 9 is a perspective view of an illustrative window with compound curvature in accordance with an embodiment.

FIGS. 10 and 11 are cross-sectional side views of the illustrative window of FIG. 9 in accordance with an embodiment.

FIG. 12 is a diagram of a glass layer being cut with cutting equipment to form multiple edge-matched glass layer sections in accordance with an embodiment.

FIG. 13 is a view of a portion of an illustrative system having windows formed from edge-matched glass layer sections in accordance with an embodiment.

FIG. 14 is a diagram of a window formed by joining multiple glass panels at seams with overlapping panel edge portions in accordance with an embodiment.

FIG. 15 is a cross-sectional side view of the illustrative window of FIG. 14 in accordance with an embodiment.

### DETAILED DESCRIPTION

A system may have one or more windows or other transparent structures. Windows with matched edges may be formed by dividing glass panels into multiple sections. Windows may also be formed by joining glass panels together.

The system in which the windows are used may be a building, a vehicle, or other suitable system. Illustrative configurations in which the system is a vehicle may sometimes be described herein as an example. This is merely illustrative. Window structures may be formed in any suitable systems.

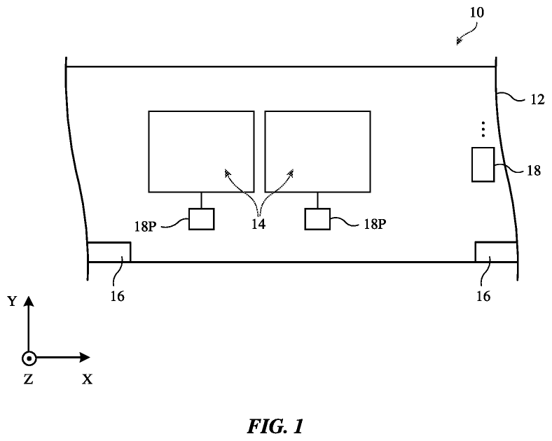

An illustrative system of the type that may include windows is shown in FIG. 1. System 10 may be a vehicle, building, or other type of system. In an illustrative configuration, system 10 is a vehicle. As shown in the illustrative side view of system 10 in FIG. 1, system 10 may have support structures such as body 12. Body 12 may be a vehicle body that includes doors, trunk structures, a hood, side body panels, a roof, window pillars, and/or other body structures. Body 12 may be configured to surround and enclose an interior region.

One or more windows such as windows 14 may be mounted within openings in body 12. Windows 14 may, for example, be mounted on the front of body 12 (e.g., to form a front window on the front of a vehicle), on the rear of body 12 (e.g., to form a rear window at the rear of a vehicle), on the top of body 12 (e.g., to form a sun roof), and/or on sides of body 12 (e.g., to form side windows). Windows 14 (e.g., front and rear windows) may include windows that are fixed in place and/or may include windows that can be manually and/or automatically rolled up or down. For example, one or more windows 14 may be controlled using window positioners 18P (e.g., window motors that open and close windows 14 in response to user input or other input). The area of each window 14 may be at least 0.1 m², at least 0.5 m², at least 1 m², at least 5 m², at least 10 m², less than 20 m², less than 10 m², less than 5 m², or less than 1.5 m² (as examples). Windows 14 and portions of body 12 may be used to separate the interior region within system 10 from the exterior environment that is surrounding system 10.

System 10 may include a chassis to which wheels are mounted (e.g., wheels 16), may include propulsion and steering systems, may include a vehicle automation system configured to support autonomous driving (e.g., a vehicle automation system with sensors and control circuitry configured to operate the propulsion and steering systems based on sensor data). This allows system 10 to be driven semi-autonomously and/or allows system 10 to be driven autonomously without a human operator.

System 10 may include components such as window positioners 18P and other components 18. Components 18 may include seats in the interior of body 12, sensors, control circuitry, input-output devices, and/or other vehicle components. Control circuitry in system 10 may include one or more processors (e.g., microprocessors, microcontrollers, application-specific integrated circuits, etc.) and storage (e.g., volatile and/or non-volatile memory). Input-output devices in system 10 may include displays, sensors, buttons, light-emitting diodes and other light-emitting devices, haptic devices, speakers, and/or other devices for providing output and/or gathering environmental measurements and/or user input. The sensors may include ambient light sensors, touch sensors, force sensors, proximity sensors, optical sensors, capacitive sensors, resistive sensors, ultrasonic sensors, microphones, three-dimensional and/or two-dimensional images sensors, radio-frequency sensors, and/or other sensors. Output devices may be used to provide a user with haptic output, audio output, visual output (e.g., displayed content, light, etc.), and/or other suitable output.

During operation, control circuitry in system 10 may gather information from sensors and/or other input-output devices, user input such as voice commands provided to a microphone, a touch command supplied to a touch sensor, button input supplied to one or more buttons, etc. Control circuitry in system 10 may use this input in autonomously driving system 10 and in controlling components in system 10. For example, the control circuitry can use positioners 18P to open and close windows 14.

Windows such as window 14 may be coupled to body 12 and may be configured to cover openings in body 12. In some configurations, the edges of adjacent windows may be matched to each other. For example, windows may be cut from a common panel so that, for example, the right-hand edge of a first window is matched to the corresponding left-hand edge of a second window that is adjacent to the first window. Such matched edges may, if desired, overlap supporting body structures such as window pillars.

Window 14 may be flat (e.g., window 14 may lie in the X-Y plane of FIG. 1) or window 14 may have one or more curved portions. As an example, window 14 may have a curved cross-sectional profile and may be oriented to lie generally parallel to the X-Y plane so that a convex surface of window 14 faces outwardly in direction Z of FIG. 1. Other orientations may be used, if desired. The area of each window 14 in system 10 may be at least 0.1 m², at least 0.5 m², at least 1 m², at least 5 m², at least 10 m², less than 20 m², less than 10 m², less than 5 m², or less than 1.5 m² (as examples).

Window 14 may be formed from one or more layers of transparent glass, clear polymer (e.g., polycarbonate, acrylic, etc.), polymer adhesive, and/or other layers. For example, window 14 may be formed from two glass layers or three glass layers laminated together with adhesive. The glass layers may be chemically or thermally tempered (e.g., to create compressive stress on the surfaces of the glass layers).

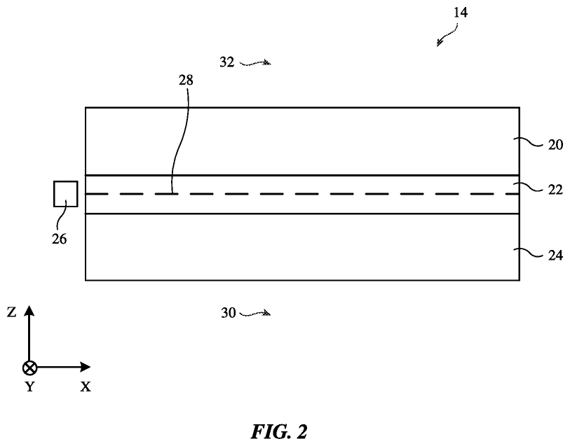

In the illustrative configuration of FIG. 2, window 14 is formed from outer window layer 20 and inner window layer 24 (e.g., outer and inner structural glass layers and/or other layers of transparent material). The thicknesses of layers 20 and 24 may be, for example, 0.5 mm to 3 mm, at least 0.3 mm, at least 0.5 mm, less than 4 mm, less than 3 mm, or other suitable thickness. Outer layer 20 and inner layer 24 may be laminated together using a polymer layer such as interposed adhesive layer 22 (e.g., an adhesive layer with one surface bonded to the inwardly facing surface of outer window layer 20 and an opposing surface bonded to the outwardly facing surface of inner window layer 24). Adhesive layer 22 may have a refractive index that is matched (e.g., within 0.1, within 0.07, within 0.05, or within 0.03) to that of layers 20 and 24. Examples of polymers that may be used for forming adhesive layer 22 include thermoplastic polyurethane, ethylene-vinyl acetate, and polyvinyl butyral. Layer 22 may, if desired, include polymer configured to provide sound dampening (e.g., a soft polyvinyl butyral sublayer or other acoustic film embedded within layer 22).

Outer window layer 20 may be formed from a single layer of structural window glass or may include multiple sublayers such as one or more layers of glass, optically clear adhesive, and/or polymer films. Inner window layer 24 may similarly be formed from a single layer of structural window glass or may include multiple sublayers such as one or more layers of glass, optically clear adhesive, and/or polymer films. In some configurations, a window may be formed by joining a pair of window panels along a seam. Each panel in this type of arrangement may include multiple laminated window layers such as outer layer 20 and inner layer 24. Portions of the inner and outer layers may overlap each other along the seams.

If desired, optional fixed and/or adjustable optical components may be incorporated into window 14. As shown in FIG. 2, for example, one or more optical components such as optical layer 28 may be incorporated into window 14 (e.g., one or more layers such as layer 28 may be embedded in adhesive layer 22). Each layer 28 may be a fixed and/or adjustable optical layer providing fixed and/or adjustable amounts of opacity, polarization, reflection, color cast, haze, and/or other optical properties. In an illustrative configuration, layer 28 may be a light guide that receives light from light source 26. Light source 26 may, as an example, include an array of light-emitting devices such as light-emitting diodes and/or laser diodes that provide the edge of the light guide with visible light that is guided across window 14 within the light guide by total internal reflection. Light-scattering structures may be provided in window 14 to extract some of the guided light from the light guide (e.g., inwardly to produce illumination for interior region 18 and/or outwardly). Arrangements for window 14 that include an illuminated light guide and/or one or more additional fixed and/or adjustable optical layers may also be used. Configurations for window 14 in which optical components such as optical component layer 28 of FIG. 1 have been omitted may sometimes be described herein as an example.

The windows in system 10 may be completely planar (e.g., the inner and outer surfaces of window 14 may be flat) and/or some or all of the windows in system 10 may have surface curvature.

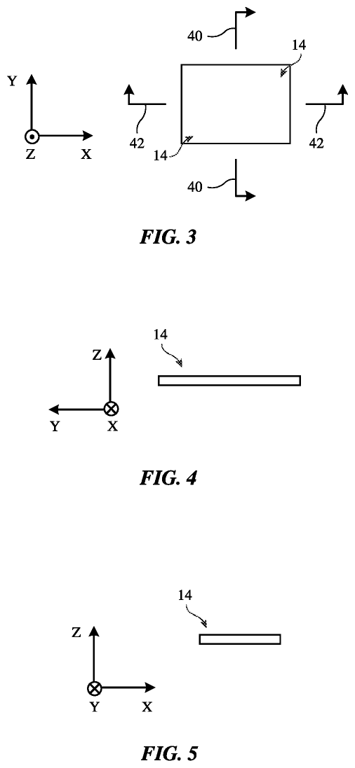

FIG. 3 is a top view of an illustrative window formed from a planar glass panel. The panel may include window structures such as outer layer 20, adhesive layer 22, and inner layer 24 (see, e.g., window 14 of FIG. 2). Windows may have rectangular outlines, outlines with curved edges, and/or outlines forming other shapes (e.g., shapes with one or more curved edges and/or one or more straight edges). In the example of FIG. 3, window 14 has a rectangular outline. Because window 14 of FIG. 3 is planar, window 14 of FIG. 3 has flat cross-sectional profiles. FIG. 4 is a cross-sectional side view of window 14 of FIG. 3 taken along lines 40 of FIG. 3 and viewed in the +X direction. FIG. 5 is a cross-sectional side view of window 14 of FIG. 3 taken along lines 42 and viewed in the +Y direction. As this example demonstrates, when window 14 is formed from a flat glass panel, the cross-sectional profiles of window 14 will be straight when viewed along orthogonal X and Y dimensions.

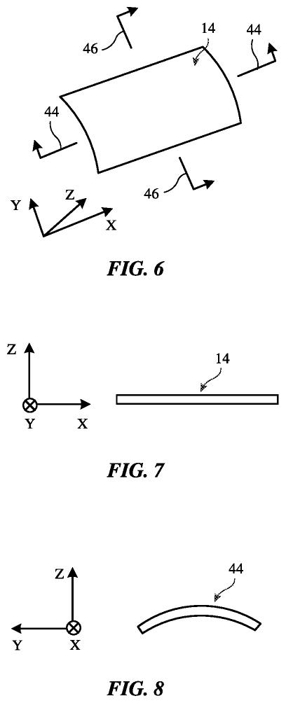

FIG. 6 is a perspective view of an illustrative window with a curved shape. In the example of FIG. 6, the surface of window 14 is a developable surface. As a result, the surface of window 14 of FIG. 6 has zero Gaussian curvature and can be flattened without distortion. FIG. 7 is a cross-sectional side view of window 14 of FIG. 6 taken along lines 44 of FIG. 6 and viewed in the +Y direction. As shown in FIG. 7, the cross-sectional profile of window 14 viewed in the +Y direction is straight. FIG. 8 is a cross-sectional side view of window 14 of FIG. 6 taken along lines 46 of FIG. 6 and viewed in the +X direction. As shown in FIG. 8, the cross-sectional profile of window 14 viewed in the +X direction is curved. Curved-surface windows such as developable-surface window 14 of FIG. 6 may have any suitable outline (rectangular, triangular, circular, shapes with curved edges and/or straight edges, etc.) and may have planar portions in addition to areas with surface curvature.

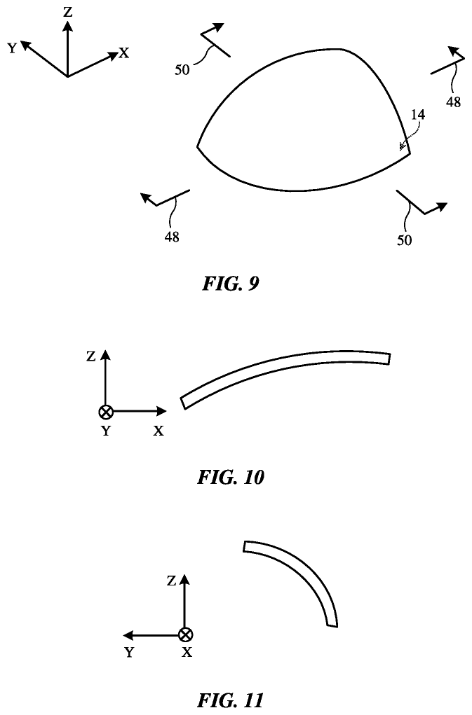

FIG. 9 is another perspective view of an illustrative curved window. In the example of FIG. 9, the surface of window 14 has compound curvature. In particular, window 14 has a non-developable surface characterized by curved cross-sectional profiles taken along the X and Y directions of FIG. 9). FIG. 10 is a cross-sectional side view of window 14 of FIG. 9 taken along lines 48 and viewed in the +Y direction. As shown in FIG. 10, the cross-sectional profile of window 14 viewed in the +Y direction is curved. FIG. 11 is a cross-sectional side view of window 14 of FIG. 9 taken along lines 50 of FIG. 9 and viewed in the +X direction. As shown in FIG. 11, the cross-sectional profile of window 14 viewed in the +X direction is curved. Windows with compound curvature may, if desired, also have one or more areas that are planar (not curved) and/or one or more areas that have developable surfaces (curved surface areas without compound curvature). Windows with compound curvature may have any suitable outline (rectangular, triangular, circular, shapes with curved edges and/or straight edges, etc.).

Window panels for forming windows 14 may be formed from single layers of glass or from multiple layers of glass laminated together as described in connection with FIG. 2. Laminated glass panels may be cut into shape using laser cutting tools, waterjet cutting tools, or other glass cutting equipment.

In systems in which adjacent window edges are mounted in body 12 close to each other, there is a potential for window edge misalignment. To ensure accurate edge alignment, a glass panel such as a laminated glass panel containing multiple glass layers (e.g., outer layer 20 and inner layer 24 of FIG. 1) may be cut into individual sections. The panels may be cut into sections after forming these panels into desired shapes. For example, the panels may be cut into sections after the panels have been formed into shapes with planar portions, curved-surface portions with developable surfaces, and/or curved-surface portions with compound curvature (e.g., after deforming planar glass panel stock into desired window shapes using heat, gravity, and/or pressure from a mold).

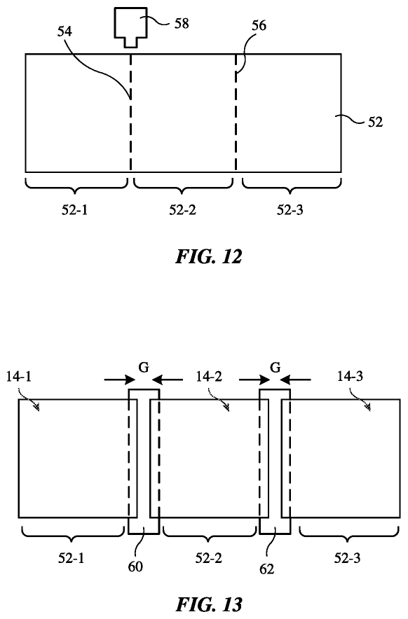

The process of cutting glass panels into sections is illustrated in the example of FIG. 12. Glass panel 52 of FIG. 12 may be planar, may have curved-surface portions with developable surfaces, and/or may have curved-surface portions with compound curvature. In the example of FIG. 12, glass panel 52 is being cut into three separate sections 52-1, 52-3, and 52-3 along respective cut lines 54 and 56 by cutting tool 58 (e.g., a laser, waterjet cutter, etc.). The use of cutting equipment to cut a glass panel into three separate pieces is illustrative. Glass panels can be cut into a pair of sections, into more than three sections, or any other suitable number of subdivided portions.

After cutting panel 52 into a desired number of sections, the sections can be used in forming windows in system 10. As shown in FIG. 13, for example, a first window 14-1 may be formed by mounting first section 52-1 of panel 52 into a first opening in body 12, a second window 14-2 may be formed by mounting second section 52-2 of panel 52 into a second opening in body 12, and a third window 14-2 may be formed by mounting third section 52-3 of panel 52 into a third opening in body 12. Gaps G (e.g., gaps of less than 10 mm, less than 5 mm, less than 1 mm, or less than 0.25 mm, may be formed between adjacent edges of the cut sections).

In system 10, gaps G may, if desired, overlap portions of body 12 such as window pillar 60 and window pillar 62 in the example of FIG. 13. Pillar 60 may be formed along the right hand edge of a body opening that is covered by window 14-1 when window 14-1 is closed and pillar 62 may be formed along the left-hand edge of an opening in body 12 that is covered by window 14-3 when window 14-3 is closed. The edges of windows 14-1 and 14-3 may each partially overlap pillars 60 and 62, respectively. Center window 14-2 in the example of FIG. 13 may have left and right edges that partly overlap pillars 60 and 62, respectively.

In arrangements of the type shown in FIG. 13, accurate edge-to-edge alignment between opposing window edges is ensured by forming the opposing window edges using the shared cut lines in panel 52. For example, the right-hand edge of window 14-1 is accurately matched to the opposing left-hand edge of window 14-2 because sections 52-1 and 52-2 were divided along cut line 54 (FIG. 12) from a common panel (panel 52). Similarly, the right-hand edge of window 14-2 will be accurately matched to the opposing left-hand edge of window 14-3 because sections 52-1 and 52-2 were divided from panel 52 along cut line 56 (FIG. 12).

Windows such as the windows of FIG. 13 that have mating edges formed from shared glass panel cut lines may sometimes be referred to as being formed from edge-matched window panel sections or shared-cut-edge-matched window panel sections. For example, windows 14-1 and 14-2 in the example of FIG. 3 are formed from edge-matched window panel sections 52-1 and 52-2 of panel 52, because the right-hand edge of glass panel section 52-1 and the corresponding adjacent left-hand edge of glass panel section 52-2 were formed from a shared cut line (cut line 54). Similarly, windows 14-2 and 14-3 are formed from edge-matched window panel sections of panel 52, because the right-hand edge of glass panel section 52-2 and the opposing left-hand edge of glass panel section 52-3 were formed from shared cut line 56 of FIG. 12.

When mounted into system 10, the windows with shared-cut-edge-matched window panel (glass layer) sections will match accurately along their adjacent edges, thereby ensuring that the uniformity of gaps G will not be adversely impacted by panel shape variations.

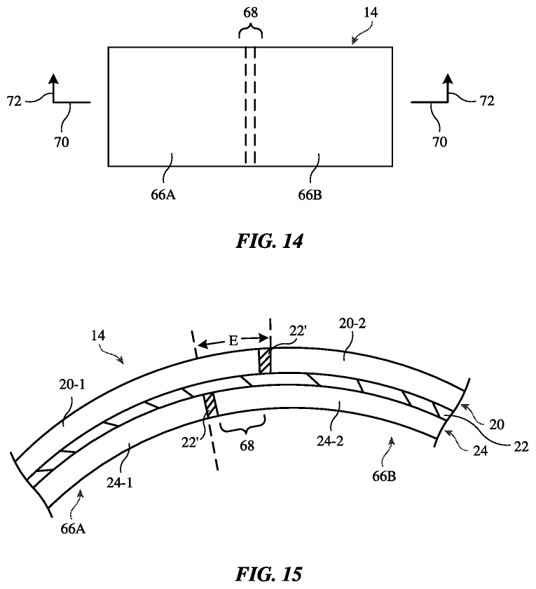

In some systems, windows of a desired size may be formed by attaching multiple panels together. FIGS. 14 and 15 illustrate how a pair of window portions can be joined along a seam (seam 68) to form a window.

As shown in FIG. 14, window panel portion 66A may be joined to window panel portion 66B along seam 68 to form window 14. In the example of FIG. 14, the outline of window 14 is rectangular. In general, window 14 may have an outline with straight and/or curved edges. Window 14 may have areas that are planar and/or that have curved cross-sectional profiles (e.g., curved-surface areas with developable surfaces and/or curved-surface areas with compound curvature). The glass panels that are used in forming window 14 may have multiple laminated glass layers. For example, each panel portion may have a pair of glass layers laminated together with polymer as described in connection with layers 20, 22, and 24 of FIG. 1. Seam 68 may be a staggered glass layer seam in which glass layers from portions 66A and 66B are laterally shifted so that they overlap each other and form a half-lap joint.

This type of overlapping seam structure is shown in FIG. 15, which is a cross-sectional side view of window 14 of FIG. 14 taken along lines 70 and viewed in direction 72. As shown in FIG. 15, window 14 may be formed from glass panel portions that each have a pair of glass layers. Window panel portion 66A may include outer glass layer 20-1 and inner glass layer 24-1. Window panel portion 66B may include outer glass layer 20-2 and inner glass layer 24-2. Along seam 68, outer window layer 20-1 may have an edge portion that extends outwardly (to the right in FIG. 15) for distance E without overlapping layer 24-1. In a complementary fashion, outer window layer 20-2 may be recessed in seam 68 by distance E relative to lower window layer 24-1 in window panel portion 66B (and layer 24-2 may therefore protrude leftward into seam 68 by distance E without overlapping any of layer 20-2 in seam 68). This staggered placement of the glass layers in each portion of window 14 allows a half-lap joint to be formed between portions 66A an 66B. Adhesive 22 is used to bond layers 20-1 and 24-1 together in portion 66A, is used to bond layers 20-2 and 24-2 together in portion 66B, and is used to bond portions 66A and 66B together along seam 68 by bonding the protruding portion of layer 20-1 in seam 68 to the mating protruding portion of layer 24-2 in seam 68.

If desired, small gaps between the opposing edge faces of layers 20-1 and 20-2 and between the opposing edge faces of layers 24-1 and 24-2 may be filled with polymer 22′. Polymer 22′ may be part of polymer 22 and/or may be a separate gap-filling polymer. Polymer 22′ may be thermoplastic polyurethane, ethylene-vinyl acetate, or polyvinyl butyral or may be a polymer such as acrylic or epoxy (as examples). Polymer 22 and polymer 22′ may be index-matched to the glass forming layers 20 and 24 (e.g., within 0.15, within 0.1, or within 0.05 as examples) to help reduce light reflections and therefore help reduce the visibility of seam 68.

The bonding arrangement of FIG. 15, forms a window that includes an outer glass layer with first and second portions 20-1 and 20-2 joined along seam 68 and that includes an attached inner glass layer with first and second portions 24-1 and 24-2 joined along seam 68. By forming windows such as window 14 of FIG. 15 in this way, relatively large windows 14 may be formed from smaller glass panels. By combining multiple window portions together to form window 14, the surface strain (the percentage of stretch/compression in a local area to form a shape from flat) of each individual window potion (which tends to increase with increasing size) may be maintained below a desired surface strain threshold amount (e.g., below 8%, below 7%, below 5%, below 3%, etc.) without overly restricting the size of window 14. If desired, three or more window portions may be joined along seams such as seam 68. The example of FIGS. 14 and 15 in which a pair of window portions are joined to form window 14 is illustrative.

The illustrative window of FIGS. 14 and 15 has two laminated glass layers, but window 14 may, if desired, include three or more glass layers stacked together. As an example, portion 66A may have three laminated layers in which the middle layer protrudes to the right and portion 66B may have three laminated layers in which the middle layer is recessed by a corresponding amount to the right, thereby allowing seam 68 to form a tongue and groove joint.

System 10 may include both one or more windows formed edge-matched glass panels and/or one or more windows formed by jointing panels with half-lap joints or other seams. Windows in system 10 may also be formed from edge-matched glass panels that include one or more half-lap joints or other seams, if desired.

In accordance with an embodiment, a vehicle window configured to separate an interior region in a vehicle from an exterior region surrounding the vehicle, the vehicle window is provided that includes a first glass panel portion having a first inner glass layer attached to a first outer glass layer; and a second glass panel portion joined to the first glass panel portion along a seam, the second glass panel portion has a second inner glass layer attached to a second outer glass layer, the first outer glass layer extends past an edge of the first inner glass layer in the seam and does not overlap the first inner glass layer in the seam, the second inner glass layer extends past an edge of the second outer glass layer in the seam and does not overlap the second outer glass layer in the seam, and the first outer glass layer overlaps the second inner glass layer in the seam.

In accordance with another embodiment, the vehicle window includes a layer of polymer having a first portion between the first inner and outer glass layers, having a second portion between the second inner and outer glass layers, and having a third portion between the first outer glass layer and the second inner glass layer; and a light guide embedded in the layer of polymer.

In accordance with another embodiment, the vehicle window includes polymer that attaches the first outer glass layer to the second inner glass layer in the seam.

In accordance with another embodiment, the polymer extends between the first inner glass layer and the first outer glass layer and attaches the first inner glass layer to the second glass layer and the polymer extends between the second inner glass layer and the second outer glass layer and attaches the second inner glass layer to the second outer glass layer.

In accordance with another embodiment, the vehicle window includes additional polymer between opposing edge faces of the first and second outer glass layers in the seam and between opposing edge faces of the first and second inner glass layers in the seam.

In accordance with another embodiment, the vehicle window includes a layer of polymer having a first portion between the first inner and outer glass layers and having a second portion between the second inner and outer glass layers; and an optical component embedded in the layer of polymer.

In accordance with another embodiment, the optical component includes a light guide configured to guide light from a light-emitting device across the window by total internal reflection.

In accordance with another embodiment, the optical component includes an adjustable-opacity optical layer.

In accordance with an embodiment, a system is provided that includes a body; and first and second adjacent windows in the body that separate an exterior region surrounding the body from an interior region within the body, the first window and the second window are formed from respective first and second edge-matched window panel sections with adjacent matched edges.

In accordance with another embodiment, the matched edges include laser-cut edges cut from a single cut through a glass panel, the first window has a first inner glass layer and a first outer glass layer, and the second window has a second inner glass layer and a second outer glass layer.

In accordance with another embodiment, the first window has a first polymer layer that attaches the first inner glass layer to the first outer glass layer and the second window has a second polymer layer that attaches the second inner glass layer to the second outer glass layer.

In accordance with another embodiment, the body includes a window pillar and the adjacent matched edges overlap the window pillar.

In accordance with another embodiment, the system includes a first window positioner coupled to the first window and a second window positioner coupled to the second window.

In accordance with another embodiment, the body includes a vehicle body and the window pillar includes a vehicle body window pillar.

In accordance with another embodiment, the system includes an additional window formed by jointing first and second glass panel portions along a seam.

In accordance with another embodiment, the first glass panel portion has a third inner glass layer attached to a third outer glass layer and the second glass panel portion has a fourth inner glass layer attached to a fourth outer glass layer, the third outer glass layer extends past the third inner glass layer in the seam and does not overlap the third inner glass layer in the seam, the fourth inner glass layer extends past the fourth outer glass layer in the seam and does not overlap the fourth outer glass layer in the seam, and the third outer glass layer overlaps that fourth inner glass layer in the seam.

In accordance with an embodiment, a vehicle is provided that includes a vehicle body surrounding an interior region; and first, second, and third windows in the body, the first window and second windows are separated by a gap and are formed, respectively from first and second shared-cut-edge-matched window panel sections and the third window is formed from first and second window portions joined along a seam.

In accordance with another embodiment, the first and second shared-cut-edge-matched window panel sections each have inner and outer glass layers laminated with polymer.

In accordance with another embodiment, the first and second portions are joined using a half-lap joint at the seam.

In accordance with another embodiment, the first, second, and third windows includes polymer that laminates outer window glass to inner window glass and the vehicle includes at least one optical component layer embedded in at least a portion of the polymer.

In accordance with another embodiment, the vehicle includes a light source configured to emit light and the optical component includes a light guide configured to receive the emitted light.

The foregoing is merely illustrative and various modifications can be made to the described embodiments. The foregoing embodiments may be implemented individually or in any combination.

What is claimed is:

1. A vehicle window configured to separate an interior region in a vehicle from an exterior region surrounding the vehicle, the vehicle window comprising:
a first glass panel portion having a first inner glass layer attached to a first outer glass layer; and
a second glass panel portion joined to the first glass panel portion along a seam, wherein the second glass panel portion has a second inner glass layer attached to a second outer glass layer, wherein the first outer glass layer extends past an edge of the first inner glass layer in the seam and does not overlap the first inner glass layer in the seam, wherein the second inner glass layer extends past an edge of the second outer glass layer in the seam and does not overlap the second outer glass layer in the seam, and wherein the first outer glass layer overlaps the second inner glass layer in the seam.

2. The vehicle window defined in claim 1 further comprising:
a layer of polymer having a first portion between the first inner and outer glass layers, having a second portion between the second inner and outer glass layers, and having a third portion between the first outer glass layer and the second inner glass layer; and
a light guide embedded in the layer of polymer.

3. The vehicle window defined in claim 1 further comprising polymer that attaches the first outer glass layer to the second inner glass layer in the seam.

4. The vehicle window defined in claim 3 wherein the polymer extends between the first inner glass layer and the first outer glass layer and attaches the first inner glass layer to the second glass layer and wherein the polymer extends between the second inner glass layer and the second outer glass layer and attaches the second inner glass layer to the second outer glass layer.

5. The vehicle window defined in claim 4 further comprising additional polymer between opposing edge faces of the first and second outer glass layers in the seam and between opposing edge faces of the first and second inner glass layers in the seam.

6. The vehicle window defined in claim 1 further comprising:
a layer of polymer having a first portion between the first inner and outer glass layers and having a second portion between the second inner and outer glass layers; and
an optical component embedded in the layer of polymer.

7. The vehicle window defined in claim 6 wherein the optical component comprises a light guide configured to guide light from a light-emitting device across the window by total internal reflection.

8. The vehicle window defined in claim 6 wherein the optical component comprises an adjustable-opacity optical layer.

9. A system, comprising:
a body; and
first and second adjacent windows in the body that separate an exterior region surrounding the body from an interior region within the body, wherein the first window and the second window are formed from respective first and second edge-matched window panel sections with adjacent matched edges.

10. The system defined in claim 9 wherein the matched edges comprise laser-cut edges cut from a single cut through a glass panel, wherein the first window has a first inner glass layer and a first outer glass layer, and wherein the second window has a second inner glass layer and a second outer glass layer.

11. The system defined in claim 10 wherein the first window has a first polymer layer that attaches the first inner glass layer to the first outer glass layer and wherein the second window has a second polymer layer that attaches the second inner glass layer to the second outer glass layer.

12. The system defined in claim 11 wherein the body comprises a window pillar and wherein the adjacent matched edges overlap the window pillar.

13. The system defined in claim 12 further comprising a first window positioner coupled to the first window and a second window positioner coupled to the second window.

14. The system defined in claim 12 wherein the body comprises a vehicle body and wherein the window pillar comprises a vehicle body window pillar.

15. The system defined in claim 9 further comprising an additional window formed by jointing first and second glass panel portions along a seam.

16. The system defined in claim 15 wherein the first glass panel portion has a third inner glass layer attached to a third outer glass layer and wherein the second glass panel portion has a fourth inner glass layer attached to a fourth outer glass layer, wherein the third outer glass layer extends past the third inner glass layer in the seam and does not overlap the third inner glass layer in the seam, wherein the fourth inner glass layer extends past the fourth outer glass layer in the seam and does not overlap the fourth outer glass layer in the seam, and wherein the third outer glass layer overlaps that fourth inner glass layer in the seam.

17. A vehicle, comprising:
a vehicle body surrounding an interior region; and
first, second, and third windows in the body, wherein the first window and second windows are separated by a gap and are formed, respectively from first and second shared-cut-edge-matched window panel sections and wherein the third window is formed from first and second window portions joined along a seam.

18. The vehicle defined in claim 17 wherein the first and second shared-cut-edge-matched window panel sections each have inner and outer glass layers laminated with polymer.

19. The vehicle defined in claim 17 wherein the first and second portions are joined using a half-lap joint at the seam.

20. The vehicle defined in claim 17 wherein the first, second, and third windows comprises polymer that laminates outer window glass to inner window glass and wherein the vehicle further comprises at least one optical component layer embedded in at least a portion of the polymer.

21. The vehicle defined in claim 20 further comprising a light source configured to emit light and wherein the optical component comprises a light guide configured to receive the emitted light.
